(19) United States
(12) Patent Application Publication
(10) Pub. No.: US 2002/0103675 A1
(43) Pub. Date: Aug. 1, 2002

(54) Apparatus and method for providing consolidated medical information

(76) Inventor: John Vanelli, Aliso Viejo, CA (US)

Correspondence Address: IRELL & MANELLA LLP, 840 NEWPORT CENTER DRIVE, SUITE 400, NEWPORT BEACH, CA, 92660, US

(21) Appl. No.: 09/945,447

(22) Filed: Aug. 31, 2001

Related U.S. Application Data
(63) Continuation-in-part of application No. 09/696,100, filed on Oct. 25, 2000.
(60) Provisional application No. 60/167,640, filed on Nov. 29, 1999.

(51) Int. Cl. G06F 17/60

(52) U.S. Cl. 705/3

(57) ABSTRACT

One aspect of the present disclosure relates to efficiently retrieving, organizing and updating medical information over a communication network, and to provide a seamless display of the organized information to a healthcare provider. In one embodiment, a healthcare provider uses a wireless handheld computer to access a patient's medical records that are stored on a remote server. In order to access the medical records, the patient first provides a patient identification card, while the healthcare provider supplies a user ID to the handheld computer. Once logged in, the healthcare provider can view the patient's medical records, or update those medical records with new data.

### BACKGROUND

The present application is a continuation-in-part application of U.S. patent application Ser. No. 09/696,100, entitled “Consolidated Medical Information Records” filed Oct. 25, 2000 which claims priority to U.S. provisional application serial No. 60/167,640 filed Nov. 29,1999.

### 1. FIELD

The present disclosure relates in general to an apparatus and method for providing consolidated medical information.

### 2. DESCRIPTION OF THE RELATED ART

Typically, healthcare providers maintain their patients' medical histories in paper records in a secure environment. Occasionally, some aspects of a patient's medical history may be stored in an electronic database accessible only to a particular healthcare provider. While healthcare providers may share information when, for example, a patient transfers from one healthcare provider to another, the means by which health-related information is shared and updated is currently an arduous process. This arcane system of managing patient medical information has developed, in part, due to the perceived issues surrounding the sensitivity of such information and the need for maintaining the highest levels of security.

To this end, the U.S. Government and the healthcare industries have recently set national standards for electronic filing and the transactional exchange format for health care providers. While this has improved the efficiency and the effectiveness of data management in the health care system, even a fully implemented version of this system would continue to suffer from several significant drawbacks. For example, there would still be a significant lag between when a new healthcare provider is in need of patient medical information and when it will actually be able to receive such information. This is a particularly troubling drawback when the healthcare provider is faced with an emergency situation. Additionally, updating patient medical records would continue to be a time-intensive process. Being able to update patient medical records in a timely manner, while always desirable, becomes particularly important when a patient is being treated by more than one healthcare provider at the same time, as is often the case.

Accordingly, there is a need in the industry for a system and method for overcoming the aforementioned problems.

### BRIEF SUMMARY OF THE INVENTION

The present disclosure relates to an apparatus, method, system, and computer program for providing medical information over a network. A method of the present disclosure comprises storing medical information on a remote server which is accessible to a plurality of remotely located users, providing a security token to a user computer which is in communication with said remote server and validating said security token. In addition, the method comprises transmitting a portion of said medical information from said server to said user computer over a network and displaying said portion of medical information on said user computer.

### BRIEF DESCRIPTION OF THE DRAWINGS

FIG. 1A is a system block diagram of one embodiment of a network system in which the apparatus and method of the present disclosure may be implemented.

FIG. 1B is a system block diagram of another embodiment of a network system in which the apparatus and method of the present disclosure may be implemented.

FIG. 2 is a system block diagram of one embodiment of a computer system which implements the embodiments of the invention.

FIG. 3 is one embodiment of a handheld device consistent with the present disclosure.

FIG. 4 is an illustration of a display screen of the handheld device of FIG. 3, according to one embodiment.

FIG. 5 is another illustration of a display screen of the handheld device of FIG. 3, according to another embodiment.

FIG. 6 is another illustration of a display screen of the handheld device of FIG. 3, according to yet another embodiment.

FIG. 7 is another display screen of the handheld device, according to another embodiment.

FIG. 8 is one embodiment of an identification card viewed from one side.

FIG. 9 is one embodiment of the identification card of FIG. 8, as viewed from the other side.

FIG. 10 depicts a handheld device and display screen, according to one embodiment.

FIG. 11 is a handheld device and display screen, according to another embodiment.

FIG. 12 is a handheld device and display screen, according to yet another embodiment.

FIG. 13 is a block diagram of a user login process, according to one embodiment.

FIG. 14 is a block diagram of a process of a user selecting media elements to download or upload, according to one embodiment.

FIG. 15 is a schematic of the network system of FIG. 1, according to another embodiment.

FIG. 16 is a perspective view of a cradle for use with a handheld device consistent with the present disclosure, according to one embodiment.

FIG. 17 is a side view of the cradle of FIG. 16.

FIG. 18 is another side view of the cradle of FIG. 16.

### DETAILED DESCRIPTION OF THE PREFERRED ENBODIMENTS

One aspect of the present invention relates to an apparatus and method for efficiently retrieving, organizing and updating medical information over a communication network, and to provide a seamless display of the organized information. For convenience, the present disclosure is provided in terms of organizing, updating and accessing medical information. However, it should be appreciated that the teachings herein may be applied to other forms of information as well.

In one embodiment, a Web center is connected over one or more communication links to a remote network (such as the Internet) where the remote network is accessible to users. The users may request that the Web center provide media elements on one or more pages of a Web site. The media elements may include text, a file of video clips, static photographs, JPEG images, audio clips, animation, graphics, any type of digital informational material or any combination thereof. Alternatively, users may request that the Web center provide the media elements over a network to a personal computer. In one embodiment, the media elements pertain to healthcare and health-related information. Where the Web center provides media elements to one or more pages of a Web site, users may connect to the Web site over a network, such as the Internet. Such users may include patients, doctors, paramedics, hospital administrators, insurance companies, pharmacists, or any other individual in need of accessing medical information. In one embodiment, a user is required to satisfy a security check in order to be an authorized user. In another embodiment, media elements are stored and exchanged in a commonly recognized format, such as an Electronic Data Interchange (“EDI”) standard.

While in one embodiment, users may access the media elements by accessing the Web center via a Web site using a personal computer, the media elements may also be requested and viewed by a user with a customized handheld electronic device. When viewing media elements with a handheld device, the data comprising the media elements may be transferred to the handheld device over a cellular communication link, without the need to access the Web center Web site.

Another aspect of the present invention relates to providing a secure means by which users can access the media elements. In one embodiment, the method for securely accessing the media elements includes entering an identification number (“User ID”) into a personal computer or handheld device. Thereafter, the user may be prompted to insert an identification card (“ID Card”) into the personal computer or handheld device. In one embodiment, access to the Web center is granted only where the User ID provides a match with the ID Card inserted. It should be appreciated that this double-authentication system may instead begin with a user inserting their ID Card into the hand-held device, followed by the user supplying their User ID. In another embodiment, the ID Card is a “smart card,” capable of storing various types of information on it, such as an individual's latest medical history. In yet another embodiment, the user is requested to provide a biometrics security token along with their ID Card. The biometrics security token may be a fingerprint or a retinal scan, in one embodiment.

Another aspect of the present invention relates to a method for enabling certain users to have read-only access to the media elements, while enabling another category of users to have editing and updating permission. In one embodiment, when the user is a patient the user will only be allowed to view the media elements relating to their individual medical history. Where, however, the user is a physician, the user may be granted additional permissions relating to editing and updating. In one embodiment, a physician desiring to edit or update a current patient record will be required to contact the Web center via the telephone.

A further aspect of the present invention relates to providing a user with a menu system by which the media elements may be displayed on a hand-held device in an organized manner. In one embodiment, a top-level menu is displayed along one side of a view screen on the hand-held device. Upon making a selection from the top-level menu, a submenu is displayed to the user on the view screen. In one embodiment, this submenu is a pop-up menu, while in another embodiment the submenu is displayed along the other side of the view screen from the side on which the top-level menu is displayed.

### Definitions

As discussed herein, a “user computer” is a computer product including circuitry capable of processing data. The user computer may include, but is not limited to, general purpose computer systems (e.g., server, laptop, desktop, palmtop, personal electronic devices, etc.), personal computers (PCs), and the like. “Handheld device” may include any portable user computer including, but not limited to, a personal digital assistance (“PDA”), laptop, palmtop, or a specific-purpose portable electronic device. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

### System Overview

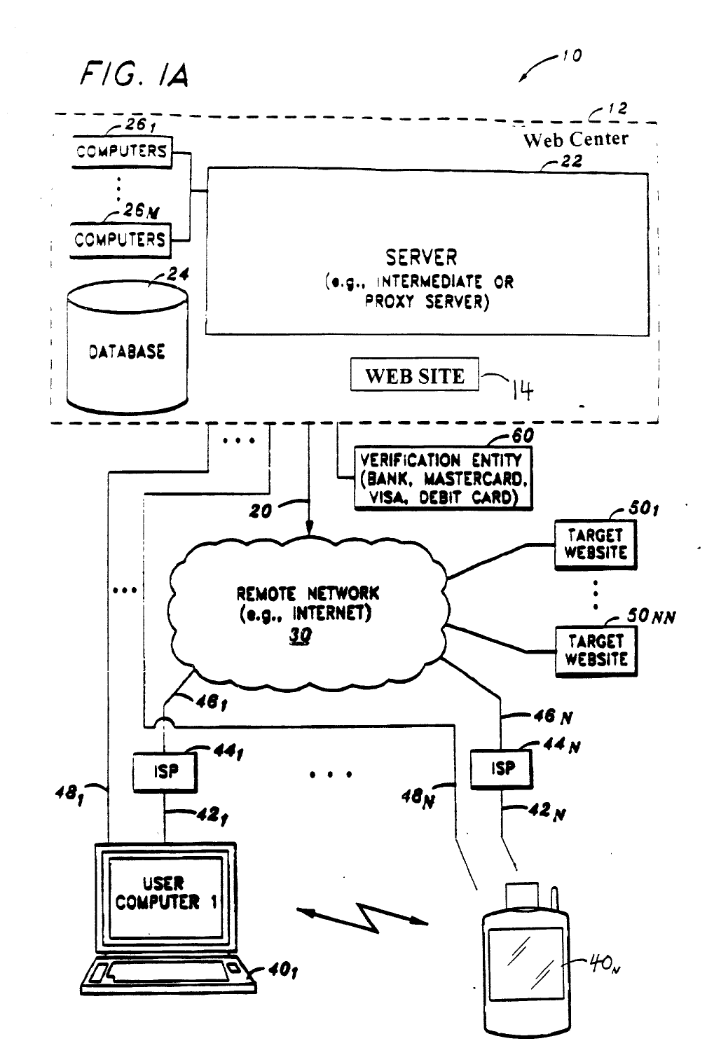

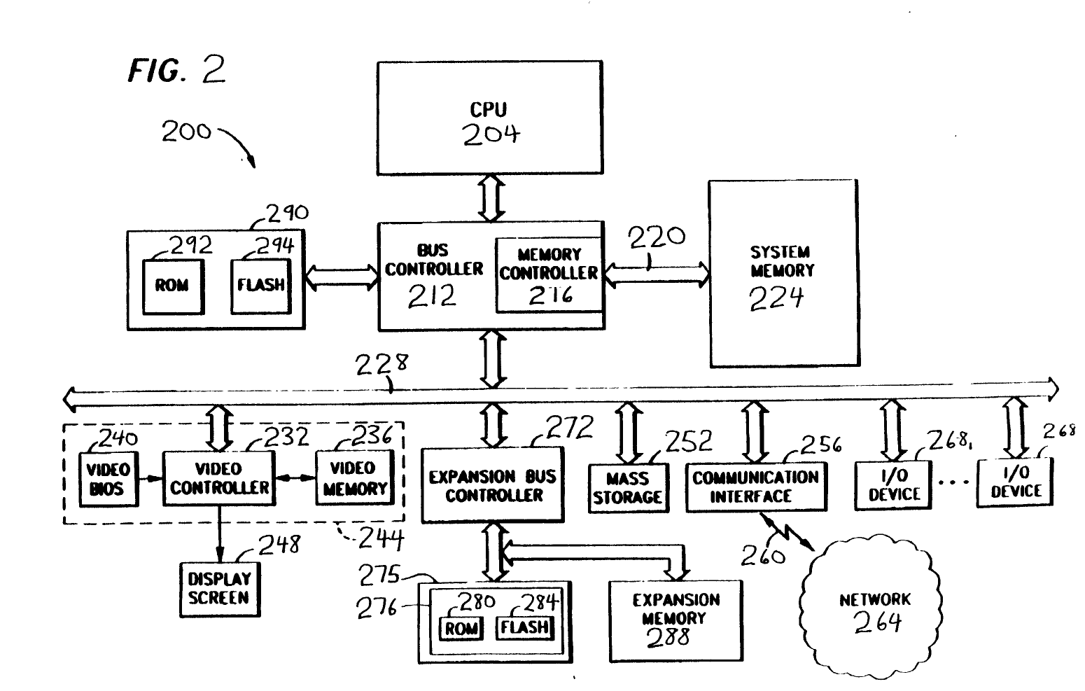

A description of an exemplary system, which incorporates embodiments of the present invention, is herein described. FIG. 1A shows a system block diagram of one embodiment of a network system 10 in which the apparatus and method of the invention is used. Referring to FIG. 1A, the network system 10 comprises a Web center 12 that is connected over one or more communication links 20 to a remote network 30 (e.g., a wide area network or the Internet) or a remote site (e.g., a satellite, which is not shown in FIG. 1A) to one or more user computer systems 40₁-40_{N} (“40”). In one embodiment, the user computer 40 is a personal computer, while in another embodiment the user computer 40 is a handheld device. In one embodiment, the Web center 12 includes a Web site 14. The Web center 12 may further include one or more servers 22 and one or more databases 24. In one embodiment, the server 22 includes software modules for performing the processes of the invention, as described in detail in the following sections.

The server 22 may be coupled to one or more verification entities such as entity 60 for verification of credit information and for processing credit transactions. The Web center 12 may also include one or more server computers 26₁-26_{M} (“26”). If a plurality of server computers are used, then the server computers 26 may be connected by a local area network (LAN) or any other similar connection technology. However, it is also possible for the Web center 12 to have other configurations. For example, a smaller number of larger computers (i.e. a few mainframe, mini, etc. computers) with a number of internal programs or processes running on the larger computers capable of establishing communication links to the user computers.

The remote network 30 or remote site allows the Web center 12 to provide information and services to the user computer(s) 40, using software that is stored at the Web center 12. The one or more databases 24 connected to server 22 and/or server computers 26, are used to store such information. Each user computer 40 is connected over a corresponding communication link 42₁-42_{N} such as a local carrier exchange to a respective ISP 44₁-44_{N}, through which access to the remote network 30 is made. By inputting the URL address of the target website with which the user desires to interact, the user may be connected to various target websites, such as target websites 50₁-50_{NN} (“50”). In an alternate embodiment, each user may be connected over a corresponding communication link 48₁-48_{N} to the Web center 12, which provides internet access and service to the user computer(s) 40. In a further embodiment, the display screen for viewing the presentation may be located on a television coupled to the network 30. For example, the end user may be a viewer of a set top box television. In this case, navigation through the presentation may be provided through the use of control buttons on a remote control unit for controlling viewing of the television, or by other means known in the art.

One aspect of the present disclosure relates to providing information management software that is capable of managing medical information in a central location and making such information available to users to access and/or update. Such a process may occur on a computer system that is separate and apart from the Web center 12, or may be developed using the server computer(s) 26. Upon completion of the development process, the information management software may be stored in the database 24. Alternatively, the information management software may be stored on a machine-readable medium.

In one embodiment, the Web center 12, which is connected over one or more communication links to a remote network, may be requested to provide medical information on one or more pages of a Web site 14. In this embodiment, the medical information, which may be stored in the form of media elements on the database 24, is used to generate one or more pages of the Web site 14. Users accessing the Web center 12 via the network may then view the selected media elements on the Web site 14. As discussed above, media elements may include text, video clips, electronic image files, audio clips, animation, and graphics. By way of non-limiting examples, media clips may include ultrasound images, x-ray images, video of medial procedures, graphs of test data, medical information recorded as sound files, or any other means of electronically storing medical and health-related information.

In another embodiment, rather than generating pages of the Web site 14 with the media elements, the Web Center 12 may provide the media elements over the network 30 directly to the user computers 40. The media elements may be requested by a user computer 40, which in one embodiment is a handheld device, by activating a link associated with a particular media element. Upon activating the link, the Web center 12 may proceed to provide the associated media element to the user computer 40 over the network 30.

Media elements may be stored in the database 24 in records. In one embodiment, all media elements pertaining to a particular patient are stored in one electronic record. The patient's record may further be divided into electronic folders, where each folder corresponds to a particular type of information. Moreover, each folder may have subfolders and so on. Alternatively, media elements may be first categorized by healthcare provider, with each record assigned to a particular healthcare provider. In such an embodiment, the folders within the record would correspond to individual patients, followed by subfolders for particular types of medical information relating to such patient. It should further be appreciated that other common forms of organizing medical information in an electronic database may be used.

Referring to FIG. 2, the computer system 200 (representing either of server computer 26 or user computer 40) comprises a processor or a central processing unit (CPU) 204. The illustrated CPU 204 includes an Arithmetic Logic Unit (ALU) for performing computations, a collection of registers for temporary storage of data and instructions, and a control unit for controlling operation for the system 100. In one embodiment, the CPU 204 includes any one of the x86, Pentium™, Pentium II™, and Pentium Pro™ microprocessors as marketed by Intel™ Corporation, the K-6 microprocessor as marketed by AMD™, or the 6x86MX microprocessor as marketed by Cyrix™ Corp. Further examples include the Alpha™ processor as marketed by Digital Equipment Corporation™, the 680X0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 204. The CPU 204 is not limited to microprocessor but may take on other forms such as microcontrollers, digital signal processors, reduced instruction set computers (RISC), application specific integrated circuits, and the like. Although shown with one CPU 204, computer system 200 may alternatively include multiple processing units.

The CPU 204 is coupled to a bus controller 212 by way of a CPU bus 208. The bus controller 212 includes a memory controller 216 integrated therein, though the memory controller 216 may be external to the bus controller 212. The memory controller 216 provides an interface for access by the CPU 204 or other devices to system memory 224 via memory bus 220. In one embodiment, the system memory 224 includes synchronous dynamic random access memory (SDRAM). System memory 224 may optionally include any additional or alternative high speed memory device or memory circuitry. The bus controller 212 is coupled to a system bus 228 that may be a peripheral component interconnect (PCI) bus, Industry Standard Architecture (ISA) bus, etc. Coupled to the system bus 228 are a graphics controller, a graphics engine or a video controller 232, a mass storage device 252, a communication interface device 256, one or more input/output (I/O) devices 268₁-268_{N}, and an expansion bus controller 272. The video controller 232 is coupled to a video memory 236 (e.g., 8 Megabytes) and video BIOS 240, all of which may be integrated onto a single card or device, as designated by numeral 244. The video memory 236 is used to contain display data for displaying information on the display screen 248, and the video BIOS 240 includes code and video services for controlling the video controller 232. In another embodiment, the video controller 232 is coupled to the CPU 104 through an Advanced Graphics Port (AGP) bus.

The mass storage device 252 includes (but is not limited to) a hard disk, floppy disk, CD-ROM, DVD-ROM, tape, high density floppy, high capacity removable media, low capacity removable media, solid state memory device, etc., and combinations thereof. The mass storage device 252 may include any other mass storage medium. The communication interface device 256 includes a network card, a modem interface, etc. for accessing network 264 via communications link 260. In addition, the communication interface device 256 may include wireless circuitry for connecting the computer system 200 to the network 264 through a commonly known cellular standard, such as CDMA. The I/O devices 268₁-268_{N} include a keyboard, mouse, audio/sound card, printer, and the like. The I/O devices 268₁-268ₙ may be disk drive, such as a compact disk drive, a digital disk drive, a tape drive, a zip drive, a jazz drive, a digital video disk (DVD) drive, a magneto-optical disk drive, a high density floppy drive, a high capacity removable media drive, a low capacity media device, and/or any combination thereof. The expansion bus controller 272 is coupled to non-volatile memory 275, which includes system firmware 276. The system firmware 276 includes system BIOS 282, which is for controlling, among other things, hardware devices in the computer system 200. The system firmware 276 also includes ROM 280 and flash (or EEPROM) 284. The expansion bus controller 272 is also coupled to expansion memory 288a having RAM, ROM, and/or flash memory (not shown). The system 200 may additionally include a memory module 290 that is coupled to the bus controller 212. In one embodiment, the memory module 290 comprises a ROM 292 and flash (or EEPROM) 294.

As is familiar to those skilled in the art, the computer system 200 further includes an operating system (OS) and may further include an application program, which in one embodiment, is loaded into system memory 224 from mass storage device 252 and launched after POST. The OS may include any type of OS including, but not limited or restricted to, DOS, Windows™ (e.g., Windows 95™, Windows 98™, Windows 2000™, Windows ME™, Windows XP™, Windows CE™, and Windows NT™), Unix, Linux, OS/2, OS/9, Xenix, etc. The operating system is a set of one or more programs which control the computer system's operation and the allocation of resources. The application program is a set of one or more software programs that performs a task desired by the user.

In accordance with the practices of persons skilled in the art of computer programming, the present invention is described below with reference to symbolic representations of operations that are performed by computer system 200, unless indicated otherwise. Such operations are sometimes referred to as being computer-executed. It will be appreciated that operations that are symbolically represented include the manipulation by CPU 204 of electrical signals representing data bits and the maintenance of data bits at memory locations in system memory 224, as well as other processing of signals. The memory locations where data bits are maintained are physical locations that have particular electrical, magnetic, optical, or organic properties corresponding to the data bits.

### Handheld Device

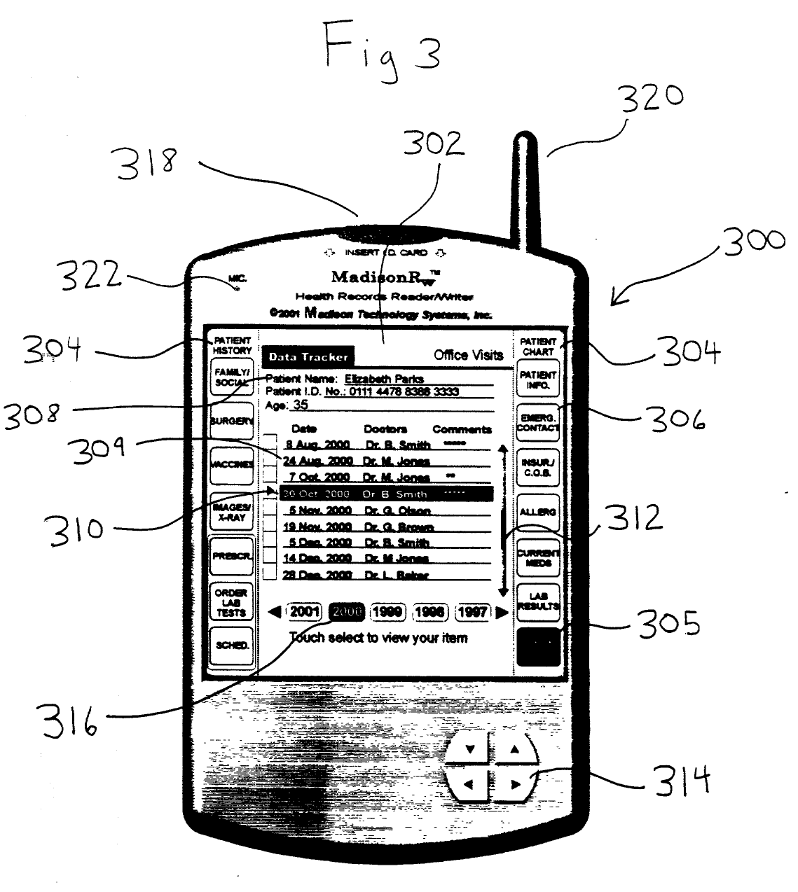

FIG. 3 illustrates one embodiment of a handheld device 300 that serve as a user computer 4o to connect to the Web center 12 via the network 30. In this embodiment, the handheld device contains a display screen 302. In one embodiment, the display screen 302 is a liquid crystal display (“LCD”) screen. After a user has logged in (as discussed in more detail below), the display screen 302 may include a menu bar 304 from which the user can make a selection. In one embodiment the user selects items from the menu bar 304 by touching the display screen 302. In this embodiment, menu bars 304 are located along both sides of the display screen 302. In addition, the menu bars 304 contain access keys 306 which correspond to particular medical information. In this embodiment, the menu bar 304 on the left contains access keys 306 for patient history information, while the menu bar 304 on contains access keys 306 for patient medical chart information. The center of the display screen 302 is used to display the particular information selected via the access keys 306, and any additional submenu options. In the embodiment of FIG. 3, the user has selected the access key 306 corresponding to office visit information. Thus, this is the category choice 305. In response to a user category choice 305, handheld device 300 will issue a request to the Web center 12 and display the results on display screen 302. It should be appreciated that the results provided by Web center 12 may include media elements or submenu data. In the embodiment of FIG. 3, the handheld device 300 is displaying patient information 308 and an office visit list 309. A scroll bar 312 may be used to indicate the relative location of a user's current selection 310 with respect to the office visit list 309 where there are more entries than can be viewed simultaneously. Navigational buttons 314 may be used to change the user's current selection 310.

The user may also be able to make additional selections from a submenu 316, which in this embodiment contains choices for the year in which the office visits occurred. Moreover, in this embodiment the handheld device 300 is equipped with a card port 318 into which a user may insert their ID Card. In one embodiment, the handheld device 320 may also be equipped with an antenna 320 to facilitate one-way or two-way cellular communication with the network 30. As discussed above, one aspect of the present disclosure is to provide a portable handheld device equipped with wireless circuitry, as known in the cellular arts, capable of providing cellular communication with Web center 12 over the network 30. In another embodiment, the handheld device 320 contains circuitry required to form a communications link, as defined above, with the Web center 12.

The handheld device may further be equipped with a microphone 322 through which voice instructions may be provided. Where voice instructions are to be provided, the handheld device 300 may further be equipped with voice recognition software. It should further be appreciated that two-way voice communication is possible where the handheld device 300 is further equipped with a speaker (not shown) and associated circuitry.

Finally, as will be discussed in more detail below, the handheld device 300 may include I/O devices 268 which enable a user to upload data to be stored at the Web center 12. In one embodiment, this I/O device 268 is an on-screen touch keyboard. It should be appreciated that any commonly known means of entering information into a handheld device may be used as well.

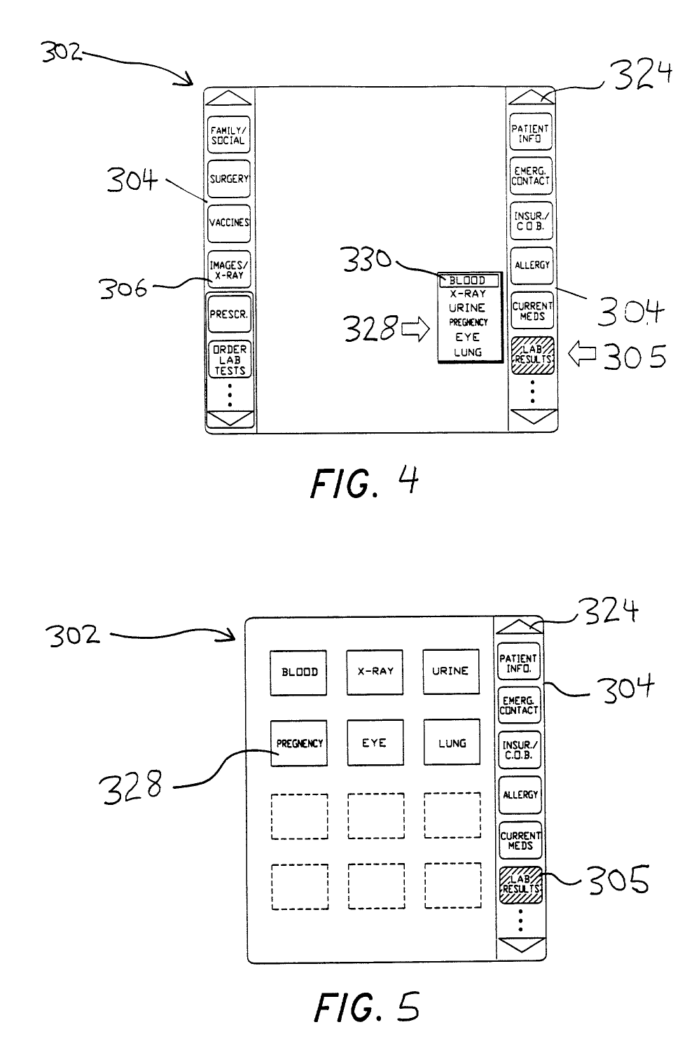

FIG. 4 depicts another embodiment of display screen 302. In this embodiment, display screen 302 contains menu bars 304 along the left and right sides that are comprised of access keys 306 relating to various categories of medical information, such as Patient Info, Emergency Contact, Insurance/C.O.B., Allergy, Lab Results, Surgery, Vaccines, and so on. In this embodiment, both menu bars 304 contain scroll arrows 324 at the top and bottom of the menu bars 304. The scroll arrows 324 serve to advance the user up or down the selections along the menu bars 304 where there are more access keys 306 than can be displayed on the display screen 302 at any one time.

Referring still to FIG. 4, in this embodiment the user has selected category choice 305, which corresponds to the Lab Results category. Where there are subcategories of medical information, as here, a submenu 328 is displayed to the user. In the embodiment of FIG. 4, the submenu 328 includes subcategories relating to Blood, X-Ray, Urine, Pregnancy, Eye, and Lung. In this embodiment, the submenu 328 is a pop-up menu. The user may then make a selection from the submenu 328 by highlighting a choice. In this embodiment, the subcategory choice 330 relates to the blood subcategory. In one embodiment, the user may navigate the menu bars 304 and submenu 328 using the navigation keys 314 or, alternatively, by touching the display screen 302.

FIG. 5 illustrates another embodiment of the display screen 302. However, rather than displaying the submenu 328 as a pop-up menu as with the previous embodiment, the submenu 328 is displayed across the display screen 302 as shown in FIG. 5.

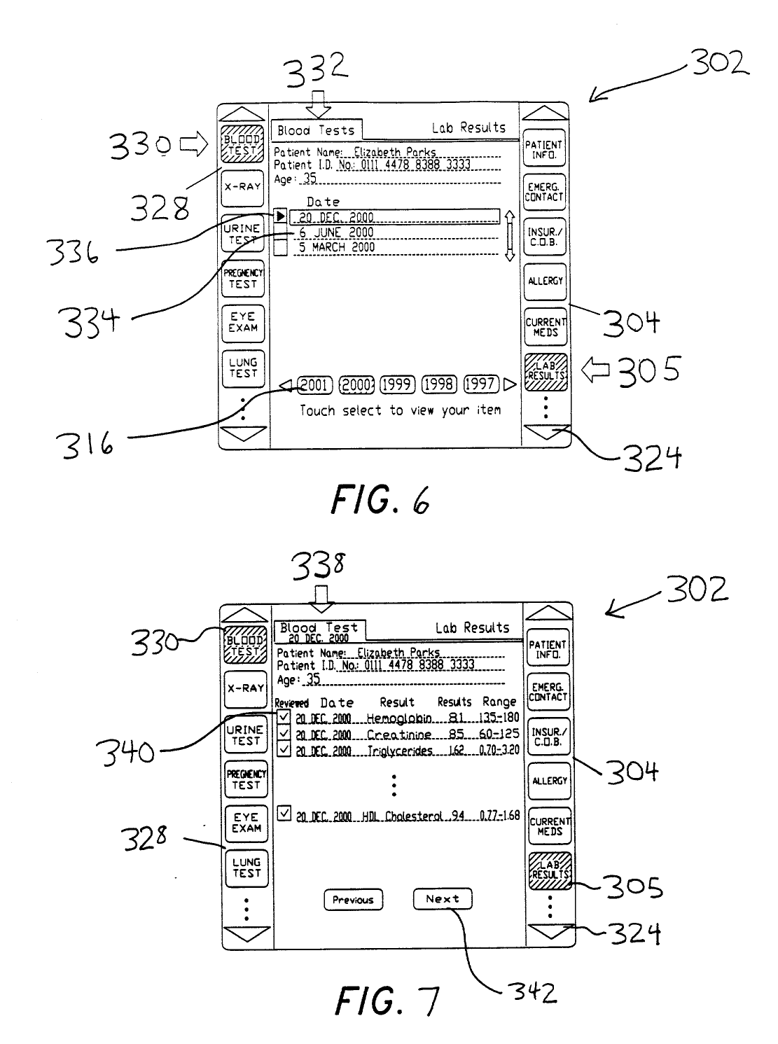

FIG. 6 is yet another embodiment of the display screen 302. As with the previous embodiment, the category choice 305 relates to the lab results category. However, in this embodiment, the submenu 328 is displayed along a side of the display screen 302, rather than as a pop-up menu or across the face of the face of the display screen. This permits the user to view the information of the subcategory, while still having the submenu 328 options visible.

Continuing to refer to FIG. 6, the subcategory 332 is displayed and contains a number of entries 334. In this case, the entries 334, corresponding to the subcategory choice 330, are dates that blood tests were conducted or reported. From this screen the user selects which entry they would like to view. In this embodiment, the user's entry choice 336 corresponds to the blood test for Dec. 20, 2000. As with FIG. 3, a submenu 316 is available to the user to narrow the entries 334 to a particular year.

It should be further appreciated that the entries 334 may also serve as links to the corresponding content for that entry 334, much in the same way as hypertext links work on the Internet. Similarly, as a user views the content of the user's entry choice 336, the content itself may contain links to content in other categories and/or subcategories.

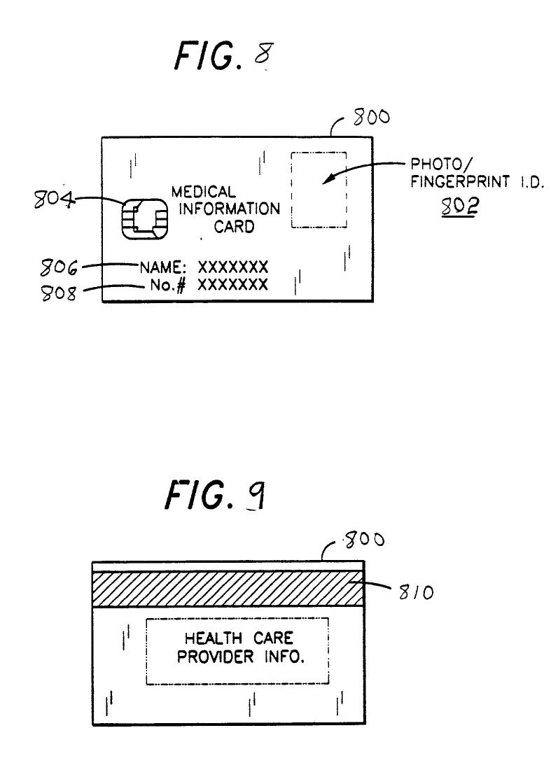

FIG. 7 is an illustration of the display screen 302 after the user has made the entry choice 336 from FIG. 6. As shown in FIG. 7, the entry contents 338 may be displayed with the menu bar 304 and submenu 328 along the right and left sides of the display screen 302, respectively. Additional navigation keys 342 may be provided where the entry contents 338 cannot be completely displayed. In one embodiment, the user may check off entry content items 340 as they are reviewed.

In another embodiment, the menu bar 304 may not be located on the display screen 302, but may rather be comprised of physical buttons on the handheld device. In one embodiment, these physical buttons are oriented along the sides of the display screen 302. These physical buttons may be programmable to correspond to a set of customized menu options. These menu options may include medical information categories, such as with access keys 306, or may correspond to performing other functions, such as power on, display setup, search records, new patient info, connect to server, etc.

FIG. 8 is one embodiment of an ID Card 800 having a smart chip 804 capable of storing data. In one embodiment, the smart chip 804 stores media elements containing the most recent medical information for a patient. ID Card 800 is also shown as having an identification section 802, which may contain photo or fingerprint information relating to the user. In addition, the ID Card 800 in this embodiment also contains a name field 806 and an account number field 808. The other side of ID Card 800 is shown in FIG. 9. A magnetic strip 810 may be used to store additional information, as is known in the art.

In another embodiment, rather than the Web center 12 provide media elements to the user computer 40 over the network 30, the Web center 12 may provide the media elements corresponding to a user request to a Web site connected to the network, such as Web Site 14. In such a case, a user having a user computer 40 connected to the network 30 would access Web Site 14 by providing the proper Web address, or URL. In one embodiment, the Web Site 14 is located on server 22, while in another embodiment Web Site 14 is one of target websites 50. In either case, only authorized users would be allowed to access the Web Site 14. The connection to the Web Site 14 from user computer 14 may also be a secure connection where the data being transmitted is encrypted using any commonly known encryption algorithm.

Similarly, a user may issue a request, using a handheld device, to the Web center 12 to view particular media elements on the Web Site 14 or target websites 50. The user may then use a computer system capable of accessing the Web site 14 to view the selected media elements. This may be needed due to the limit on the amount of memory a handheld device may contain in relation to the amount of memory the requested media elements may require.

### System Security

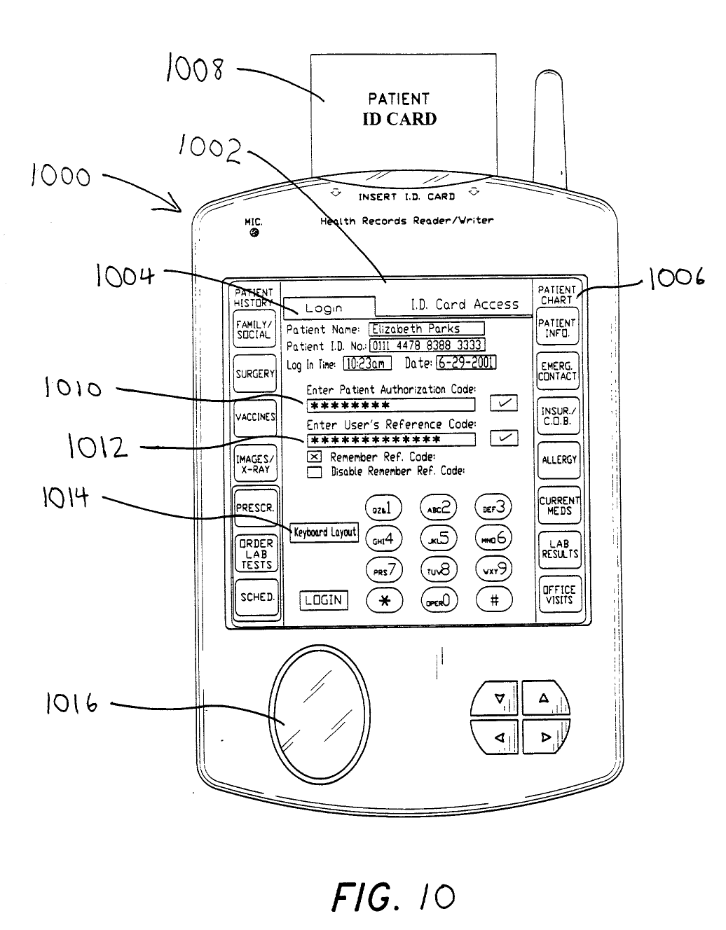

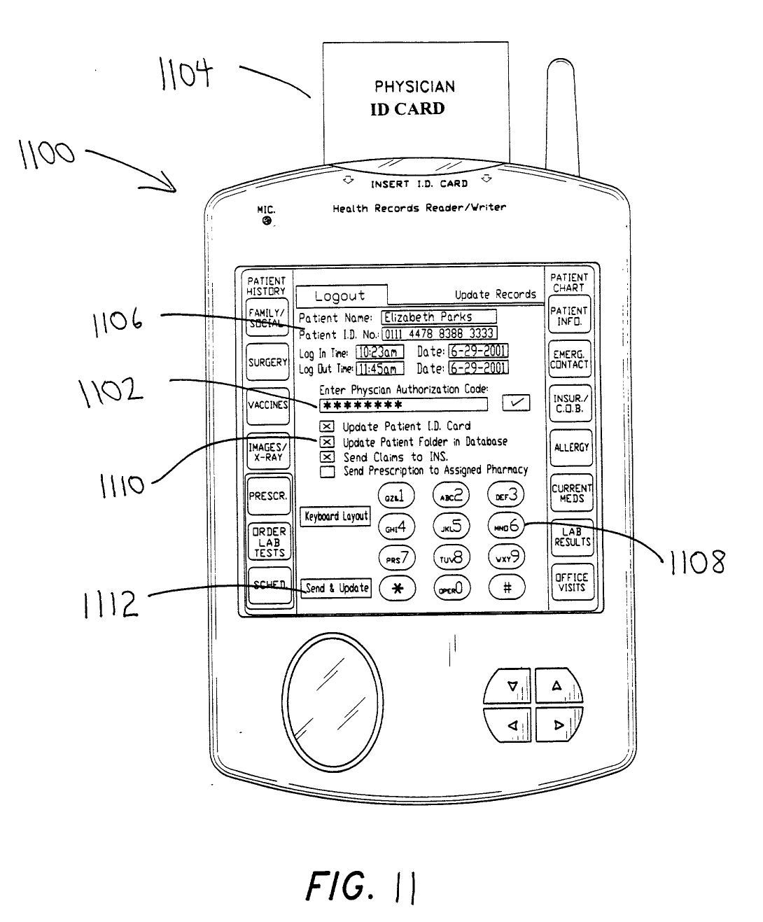

As mentioned above, one aspect of the present disclosure is to provide a means of enabling users to remotely view medical information in a secure environment. In one embodiment, the secure environment is created by employing a dual-authentication system whereby the user is required to supply both an ID card, as well as a User ID. To this end, FIG. 10 illustrates one embodiment of a handheld device 1000, having a display screen 1002, is displaying a login screen 1004. In this embodiment, the login screen 1004 is displayed with menu bars 1006 running along both the left and right sides of the display screen 1002.

In this embodiment, a patient ID Card 1008 is provided by a patient. In addition, the patient provides their patient authorization code 1010. The patient authorization code 1010 may be verified against information stored on the patient ID Card 1008. In one embodiment, the user is required to enter a user reference code 1012. In one embodiment, the user reference code 1012 is used to identify a particular user, such as a particular hospital or a particular physician. Upon insertion of the ID Card 1008 or the patient authorization code 1010, patient information may be displayed on the display screen 1002. Moreover, in one embodiment the keyboard layout may be changed by selecting a keyboard layout key 1014.

The handheld device 1000 of FIG. 10 may be further equipped with a biometrics input device 1016. The biometrics input device 1016 may be used as a supplemental means of security, whereby the patient is required to provide, not only an ID Card 1008 and a patient authorization code 1010, but also a biometrics security token. In one embodiment, the biometrics security token is a fingerprint, while in another embodiment it is a retinal scan. It should be appreciated that any commonly used biometric identification means capable of being captured in a digital format may be used. Once the biometric security token is obtained, a verification process will follow using authorization information stored on the patient ID Card 1008 itself, or information retrieved from a remote location, such as Web center 12.

In another embodiment, rather than providing an additional security measure, the biometrics input device 1016 may take the place of the patient authorization code 1010 or the patient ID Card 1008. In such a case, the input device 1016 may serve as an effective means of maintaining security where the patient has misplaced their patient ID Card 1008.

### System Applications

In one embodiment, the handheld device 1000 of FIG. 10 may be used by a physician who is treating a patient and desires to access the patient's medical history in a convenience and secure manner. In another embodiment, a physician may desire to update the medical records for one of their patients in a timely manner. As discussed previously, users of the handheld device 1000 may include any number of other parties who desire to remotely access or update the medical records for an individual and who are authorized to do so. It is generally recognized that medical information is highly sensitive and should be accessed and/or updated only by authorized healthcare providers. To this end, the combination of a patient authorization code 1010, ID Card 1008, and a user reference code 1012 serve to provide a secure environment for the medical information to be accessed. The use of the biometrics input device 1016 may further serve to protect the confidentiality of such information.

Whereas the handheld device of FIG. 10 requires the patient to be present to provide their patient authorization code 1010 and ID Card 1008, the handheld device 1100 of FIG. 11 may be used by a physician or other healthcare provider where the patient is not present. In this embodiment, the healthcare provider desires to update the medical records for a patient. In order to do so, the physician provides a physician authorization code 1102 and a physician ID Card 1104. In this embodiment the physician also provides the patient information by filling in the patient information field 1106 using the keyboard 1108. Depending on the nature of the update, the physician may also indicate what should be updated and who should receive the information. For example, in this embodiment the physician has marked the check boxes 1110 to update the patient ID Card, as well as the patient folder. The physician has also marked the check box 1110 indicating that the claims are to be sent to the insurance company. Once complete, the physician selects the Send & Update key 1112, according to one embodiment.

In one embodiment, a healthcare provider desiring to edit pre-existing medical information stored at Web center 12 is required to contact an administrator at Web Center 12 via telephone and to provide the administrator with information required to establish authorization for the alteration. In this manner, unauthorized altering of medical records will be minimized.

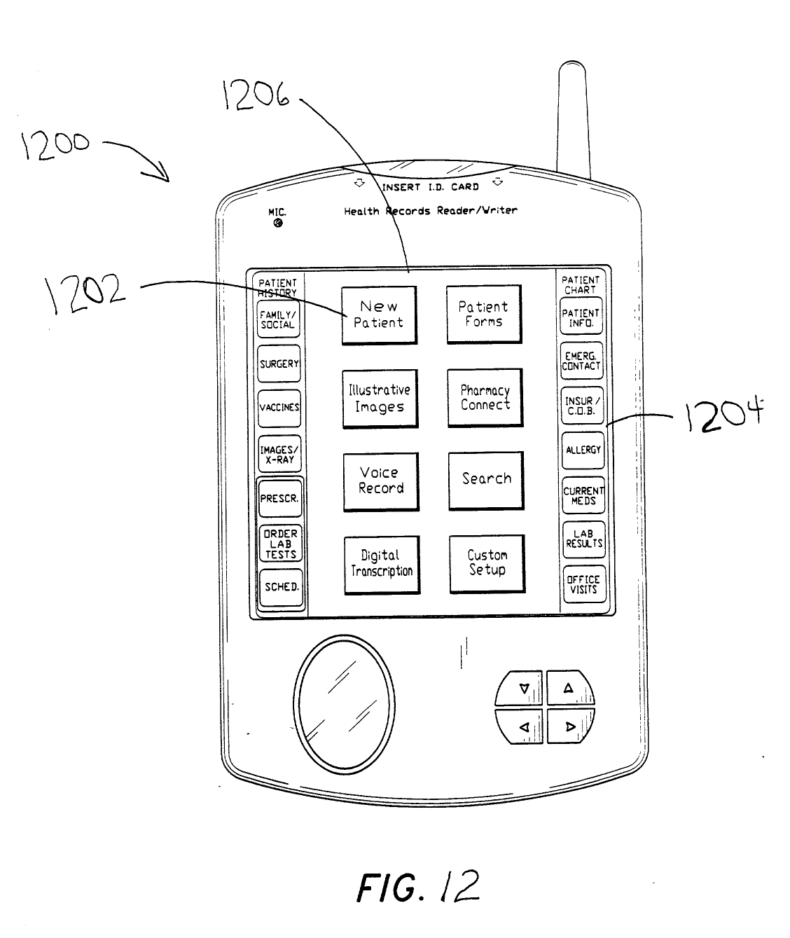

FIG. 12 provides one embodiment of a handheld device 1200 displaying a toplevel menu 1202, along with menu bars 1204 along the right and left sides of the display screen 1206. Depending on the selection made from the top-level menu 1202, the healthcare provider may be prompted for a patient ID Card, physician ID Card, and/or an authorization code.

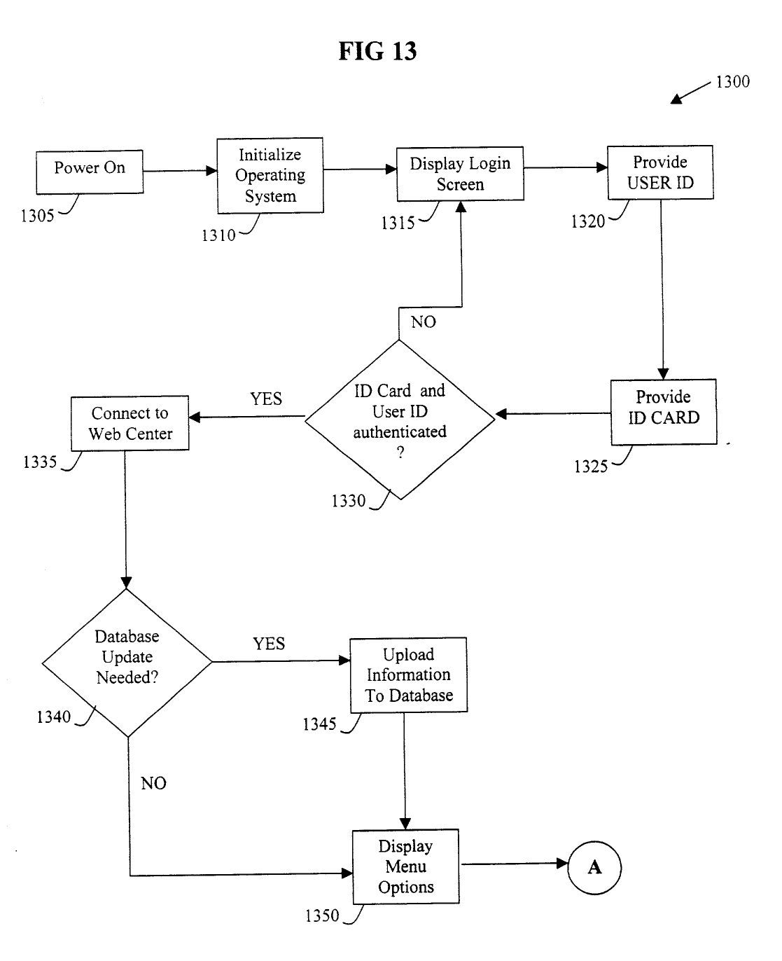

FIG. 13 is a flow diagram for a login process 1300 of a user computer 40. In one embodiment, the user computer 40 of process 1300 is a handheld device, such as handheld device 300. In another embodiment, the user computer 40 is a personal computer with an attached card reader capable of establishing a communication link between the user computer 40 and an ID Card, such as ID Card 800.

Process 1300 begins when the user computer 40 is powered on (block 1305). Thereafter the operating system for the user computer 40 is initialized (block 1310). At block 1315 a login screen is displayed to the user. In one embodiment, this login screen is login screen 1004. However, it should be appreciated that the login screen displayed at block 1315 could have any number of formats. The user is then required to provide a User ID (block 1320). In one embodiment, the user is a patient and must therefore supply a patient authorization code 1010. In another embodiment, the user is a physician and is therefore required to provide a physician authorization code 1102. As mentioned previously, the user can be any number of entities participating in the healthcare arena such as pharmacists, hospitals, administrators, insurance companies, paramedics, etc. In another embodiment, the user may be any authorized user. At block 1325, the user is required to supply an ID Card, such as ID Card 800. In one embodiment, the ID Card is inserted into a slot of a handheld device, while in another embodiment the ID Card is provided to a card reader connected to a user computer 40.

At decision block 1330, the ID Card and User ID are validated. In one embodiment, information stored on the ID Card is used to verify the User ID provided. In another embodiment, user information stored at Web center 12 is used to validate both the ID Card and User ID. Moreover, if a biometrics security token was also requested, such token could be validated against user information from the Web center 12 or ID Card.

Assuming the validation procedure was successful, the user computer 40 would be connected to the Web center at block 1335. In one embodiment, upon being connected, software at the Web center 12 determines if the ID Card contains more current information than what is stored on database 24 at the Web center 12. If so, software at Web center 12 in conjunction with software on user computer 40, updates the Web center 12 with the latest information. It should be appreciated that such information may include any number of the media elements previously discussed which are to be stored at the Web center 12 and which are capable of being stored on an ID Card, such as ID Card 800.

Once the information on the ID Card is synchronized with the information at the Web center 12, a menu screen is displayed to the user at block 1350. Where the user computer is a handheld PDA, a top-level menu may be presented to the user on a display screen, such as display screen 302. The individual access keys 306 which comprises the top-level menu will depend on the type of user seeking access and the type of information available for a given patient or subject. For example, where the user is a physician, the display screen 1206 of FIG. 12 may be displayed. Thus, in one embodiment, the data records at the Web center 12 will be used to populate the access keys 306 that comprise the top-level menu.

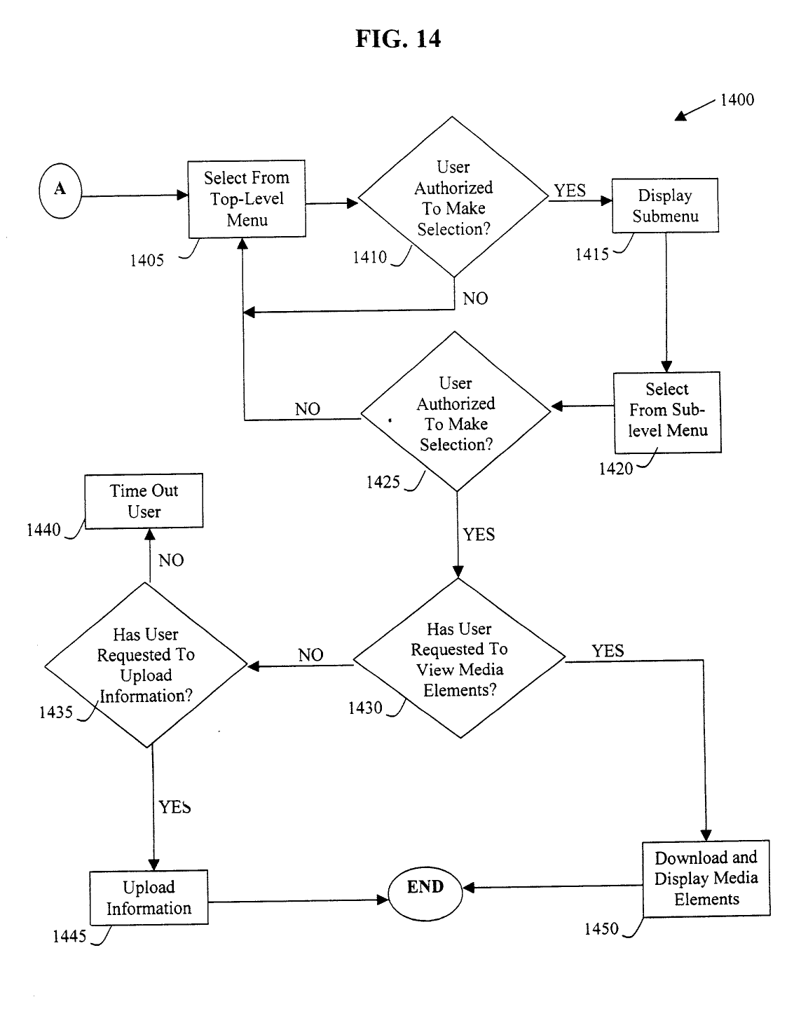

FIG. 14 continues the process of FIG. 13. In particular, an authorized user makes a selection from the top-level menu at block 1405. At decision block 1410, a determination is made as to whether the user has the proper authorization to make the selection. For example, while a primary care physician may be able to access the patient's family medical history, a pharmacist may be precluded from such information for privacy reasons. In addition, access to certain information may be limited for security reasons.

Assuming the user is authorized to make the selection, the process 1400 continues with displaying a submenu at block 1415. Again, the options comprising the submenu may depend on the user and the media elements available for display. As with the top-level menu, a determination must be made as to whether the user is authorized to view the contents of the sub-level menu selection (decision block 1425). Where a user has requested to view media elements (decision block 1430), the selected media elements are download via the network 30 and displayed on a display screen of a user computer 40.

Alternatively, where the user has requested to provide media elements to the Web center 12, such information is uploaded via the network 30 and stored at a predetermined location at Web center 12.

It should further be appreciated that some media elements will require more memory to store than will be available on a handheld device. In such a situation, the user may need to use a personal computer, equipped with a card reader as disclosed in related U.S. patent application Ser. No. 09/696,100 to download and/or upload media elements that are memory intensive.

When the user computer 40 is a handheld device, such as a PDA, it may be connected over the network 30 directly to the Web center 12, or may be connected to another computer. To this end, FIG. 15 illustrates how a handheld device, such as handheld device 300, may be connected to a personal computer 1505 via a cradle 1510. In particular, a communication link may be established between the cradle 1510 and the personal computer 1505, as shown in FIG. 15. A handheld device 300, equipped with a docking port 1520, may then be placed onto the cradle 1510 such that the docking port 1520 of the handheld device 300 forms a connection with a contact 1515 of the cradle 1510. In this manner, information may be quickly uploaded from or downloaded to the handheld device 300. Similarly, media elements provided to the personal computer 1505 over network 30 from the Web center 12, may be correspondingly transferred to the handheld device 300 via the cradle 1510, according to one embodiment.

It is another aspect of the present disclosure to enable medical information to be stored, managed and exchanged in a commonly recognized electronic format. One such format is the Electronic Data Interchange (“EDI”). One such EDI is the Health Level Seven, Inc. (“HL7”) standard which has been adopted as an alternative for certain healthcare applications, specifically for transmission of patient records and of clinical, epidemiological, and regulatory data. Other standards include the X12 standards by the Accredited Standards Committee X12 on Electronic Data Interchange (“ASC X12”). It should be appreciated that storing and exchanging information between the Web center 12 and a user computer 40 in such a standard would add to the benefits of, but not be required by, the present disclosure.

### Cradle Design

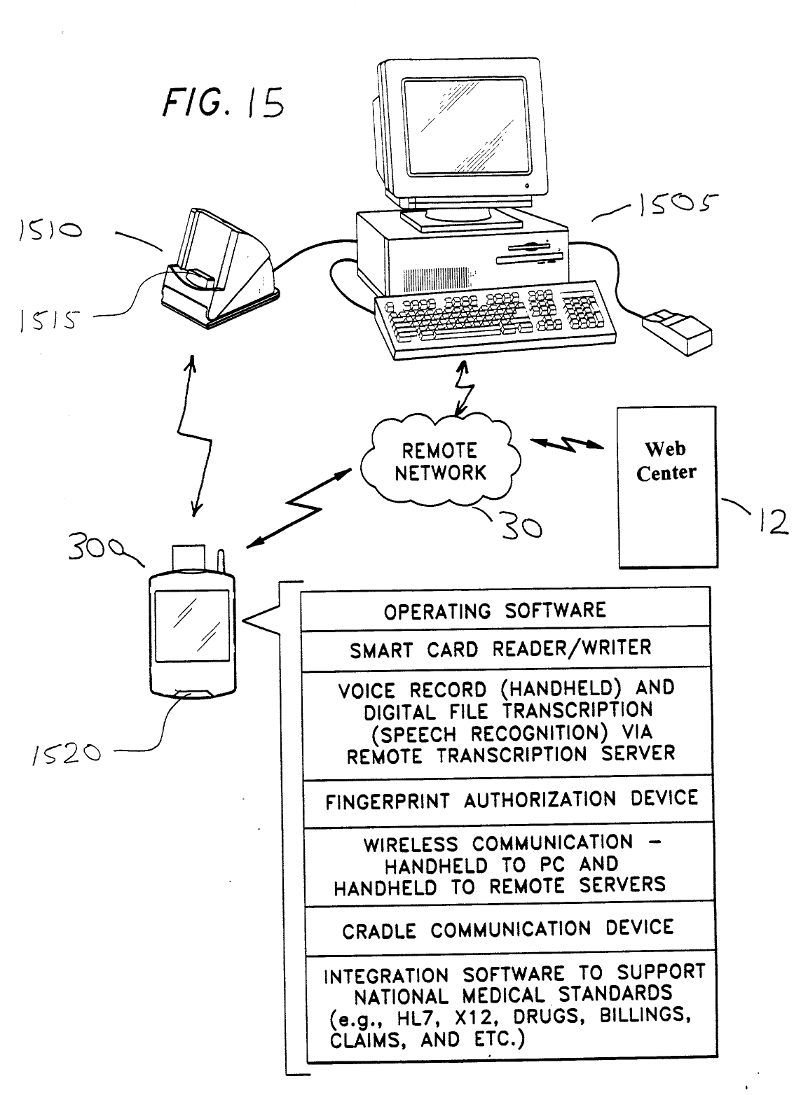

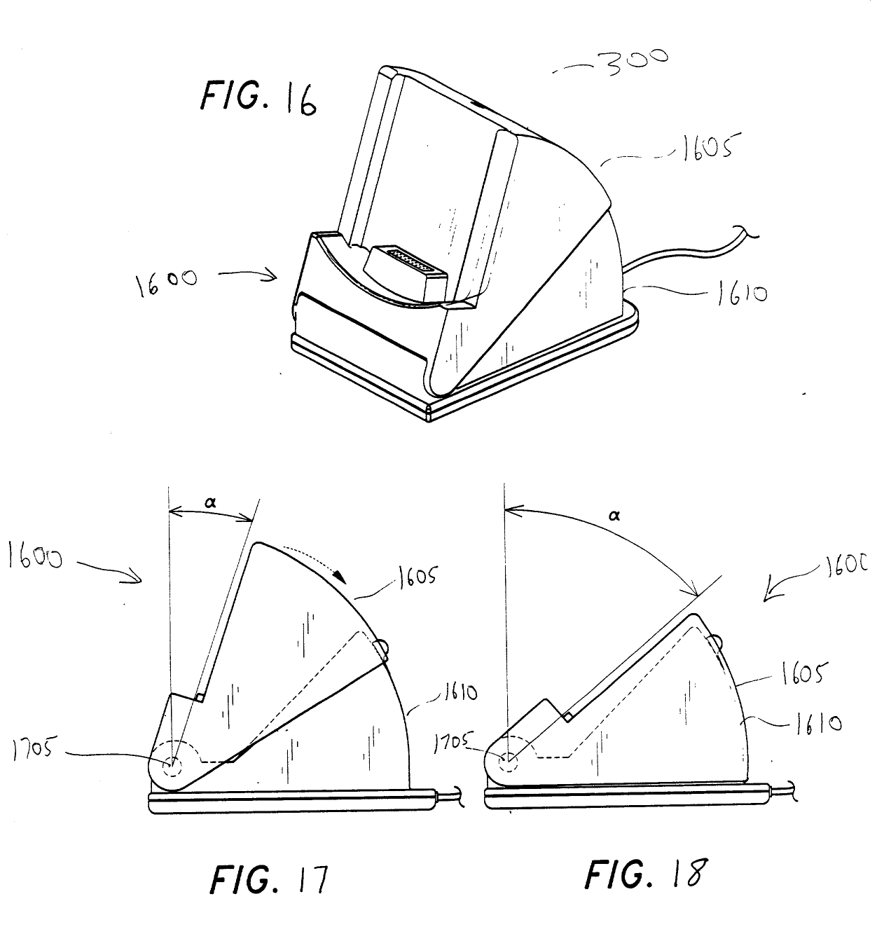

FIG. 16 illustrates one embodiment of a cradle 1600 having a design consistent with the present invention. In particular FIG. 16 shows how handheld device 300 may be positioned on cradle 1600 to establish a communication link to and from the handheld device 300. In one embodiment, Cradle 1600 is comprised of a movable portion 1605 and a base 1610, as shown in FIG. 16. FIG. 17 depicts the cradle 1600 with the moveable portion 1605 in an upright position. In one embodiment, the moveable portion 1605 pivots about axis 1705 forming an angle α, defined by a top side of the moveable portion 1605 and a vertical. FIG. 18 depicts the cradle 1600 when the top portion 1605 has been caused to further rotate about the axis 1705, thereby causing angle α to increase.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Although the present invention has been described in terms of certain preferred embodiments, other embodiments apparent to those of ordinary skill in the art are also within the scope of this invention. Accordingly, the scope of the invention is intended to be defined only by the claims that follow.

What is claimed is:

1. A handheld device for providing medical information to a user, comprising:
a housing;
a display screen located on said housing;
a memory having one or more instructions;
a port to accept a security token from the user; and,
a processor, coupled to the memory and the display screen, the processor, in response to said one or more instructions, to,
validate said security token provided by said user;
receive medical information electronically stored on a remote server over a network in response to one or more requests by said user, said remote server to be accessible by a plurality of remotely located users; and,
display said medical information on said display screen.

2. The handheld device of claim 1, wherein the display screen includes a menu bar with access keys, at least one of said access keys to link to said medical information, at least another of said access keys to cause said processor to display a submenu on said display screen.

3. The handheld device of claim 2, wherein each of said access keys correspond to a category of medical information.

4. The handheld device of claim 1, wherein said security token includes a memory and an identification section containing information associated with said user.

5. The handheld device of claim 1, wherein said security token is an identification card, said security token to be validated using information stored on said remote server.

6. The handheld device of claim 1, wherein said security token comprises a alphanumeric code corresponding to identification data stored in a memory of said security token.

7. The handheld device of claim 1, further comprising a biometrics input device, and wherein said security token comprises a fingerprint which is provided to said biometrics input device.

8. The handheld device of claim 1, wherein said medical information is electronically stored on said remote server in an electronic data interchange standard format.

9. The handheld device of claim 1, further comprising a means for providing cellular communication between said handheld device and said network, where the network is the Internet and the remote server is connected to the Internet.

10. The handheld device of claim 1, wherein said medical information is stored in an electronic database comprised of records on said remote server, said medical information to be stored in said records where each record is associated with a patient.

11. The handheld device of claim 1, wherein said processor is further to provide updated medical information to said remote server which was provided by said user, said updated medical information to be electronically stored on said remote server.

12. The handheld device of claim 11, wherein said updated medical information is provided to a computer connected to said network before being provided to said remote server.

13. The handheld device of claim 1, wherein said user is one of the following: a patient, physician, paramedic, firefighter, hospital administrator, nurse, insurer, pharmacist, and therapist.

14. A system for providing medical information to a user over a network, comprising:
a user computer having a display screen, a memory with one or more instructions, a card port for accepting an identification card, and a processor coupled to the display screen and the memory;
means for electronically storing medical information on a remote server which is accessible to a plurality of remotely located users;
means for said user to provide a security token to said user computer;
means for validating said security token; and,
means for transmitting a portion of said medical information from said remote server to said user computer over said network, said portion of medical information to be displayed to said user on the display screen.

15. The system of claim 14, wherein the display screen includes a menu bar with access keys, at least one of said access keys to link to said medical information, at least another of said access keys to cause said processor to display a submenu on said display screen.

16. The system of claim 15, wherein each of said access keys correspond to a category of medical information.

17. The system of claim 14, wherein said identification card includes a memory and an identification section containing information associated with said user.

18. The system of claim 14, wherein said security token is said identification card, said means for validating said security token to use information stored on the remote server.

19. The system of claim 14, wherein said security token comprises a alphanumeric code corresponding to identification data stored in a memory of said identification card.

20. The system of claim 14, further comprising means for inputting biometrics data, said security token to comprise a fingerprint which is to be provided to said means for inputting biometrics data.

21. The system of claim 14, wherein said means for electronically storing medical information comprises means for electronically storing medical information in an electronic data interchange standard format.

22. The system of claim 14, further comprising a means for providing cellular communication between said handheld device and said network, where the network is the Internet and the remote server is connected to the Internet.

23. The system of claim 14, wherein said means for electronically storing medical comprises means for electronically storing medical information in an electronic database comprised of records on said remote server, each of said records to be associated with a patient.

24. The system of claim 14, further comprising means for providing updated medical information to said remote server with said user computer, said updated medical information to be electronically stored on said remote server.

25. The system of claim 14, wherein said user is one of the following: a patient, physician, paramedic, firefighter, hospital administrator, nurse, insurer, pharmacist, and therapist.

26. A graphical user interface to display medical information on a user computer having a display screen, said display screen comprising,
a first screen portion to display a plurality of access keys corresponding to medical information electronically stored on a remote server, said user computer to provide a request to said remote server over a network corresponding to a user selection of one or more of said plurality of access keys, said remote server to provide a portion of said medical information in response to said request, said remote server to be accessible by a plurality of remotely located users;
a second screen portion to display a request for a security token to be provided by a user of said user computer prior to being able to select one or more of said access keys;
a third screen portion to display said portion of medical information.

27. The graphical user interface of claim 26, wherein the display screen further comprises a fourth screen portion to display a submenu in response to said user selection, said submenu to include access keys corresponding to medical information electronically stored on said remote server.

28. The graphical user interface of claim 27, wherein said second screen portion and said third screen portion each occupy at least a portion of the same area on said display screen at different times.

29. The graphical user interface of claim 26, wherein said display screen comprises a fourth screen portion to display a submenu which obstructs at least a portion of said first screen portion until said user has made a submenu selection.

30. The graphical user interface of claim 26, wherein said security token is an identification card, said security token to be validated using information stored on said remote server.

31. The graphical user interface of claim 26, wherein said security token comprises a alphanumeric code corresponding to identification data stored in a memory of an identification card.

32. The graphical user interface of claim 26, wherein said first screen portion further includes access keys to enable said user to provide updated medical information to said remote server, said updated medical information to be electronically stored on said remote server.

33. A method of providing medical information over a network comprising:
storing medical information on a remote server which is accessible to a plurality of remotely located users;
providing a security token to a user computer which is in communication with said remote server;
validating said security token;
transmitting a portion of said medical information from said server to said user computer over a network; and
displaying said portion of medical information on a display screen of said user computer.

34. The method of claim 33, wherein displaying said portion of medical information comprises displaying said portion of medical information on the display screen of said user computer, said display screen to include a menu bar with access keys, at least one of said access keys to link to said medical information, at least another of said access keys to cause said user computer to display a submenu on said display screen.

35. The method of claim 34, wherein each of said access keys correspond to a category of medical information.

36. The method of claim 33, wherein providing the security token to a user computer comprises providing an identification card to a card port on said user computer, and wherein validating said security token comprises validating said security token using information stored on said remote server.

37. The method of claim 33, wherein validating said security token comprises validating said security token where said security token is an alphanumeric code.

38. The method of claim 33, wherein providing the security token to the user computer comprises providing a security token to a biometrics input device connected to said user computer.

39. The method of claim 33, wherein storing medical information on the remote server comprises storing medical information on said remote server in an electronic data interchange standard format.

40. The method of claim 33, further comprising providing cellular communication between said user computer and said network, where the network is the Internet and the remote server is connected to the Internet.

41. The method of claim 33, further comprising providing updated medical information to said remote server by said user computer, said updated medical information to be electronically stored on said remote server.

42. A computer program embodied on a computer-readable medium for providing medical information to a user computer having a display screen, a memory with one or more instructions, a card port for accepting an identification card, and a processor coupled to the display screen and the memory, said user computer being interconnected with a remote server over a network, the computer program comprising:
a code segment that electronically stores medical information on said remote server, said remote server to be accessible to a plurality of remotely located users;
a code segment for accepting a security token from a user of said user computer;
a code segment that validates said security token;
a code segment for transmitting a request from said user computer to view a portion of said medical information to said remote server;
a code segment for responding to said request by transmitting said portion of medical information from said remote server to said user computer over the network; and,
a code segment for displaying said portion on said user computer.

43. The computer program of claim 42, wherein the display screen includes a menu bar with access keys, at least one of said access keys to link to said medical information, at least another of said access keys to cause said processor to display a submenu on said display screen.

44. The computer program of claim 43, wherein each of said access keys correspond to a category of medical information.

45. The computer program of claim 42, wherein said identification card includes a memory and an identification section containing information associated with said user.

46. The computer program of claim 42, wherein said security token is said identification card, said security token to be validated using information stored on said remote server.

47. The computer program of claim 42, wherein said security token comprises a alphanumeric code corresponding to identification data stored in a memory of said identification card.

48. The computer program of claim 42, wherein said code segment for accepting a security token comprises code segment for accepting the security token from the user, said security token to be comprises of a fingerprint which is provided to a biometrics input device.

49. The computer program of claim 42, wherein said code segment that electronically stores medical information comprises a code segment that electronically stores medical information on said remote server in an electronic data interchange standard format.

50. The computer program of claim 42, further comprising a code segment for enabling cellular communication between said user computer and said network, where the network is the Internet and the remote server is connected to the Internet.

51. The computer program of claim 42, further comprising a code segment to enable said user to provide updated medical information to said remote server, said updated medical information to be electronically stored on said remote server.

52. The computer program of claim 51, wherein said code segment to enable said user to provide updated medical information comprises code segment to enable said user to provide updated medical information to a computer connected to said network before said updated medical information is provided to said remote server.
